(19) United States
(12) Patent Application Publication
(10) Pub. No.: US 2024/0201845 A1
(43) Pub. Date: Jun. 20, 2024

(54) CONTACTLESS HUMAN-MACHINE INTERFACE FOR DISPLAYS

(71) Applicant: NXP B.V., Eindhoven (NL)

(72) Inventor: Phani Pavan Kishore Uppuluri, Bangalore (IN)

(21) Appl. No.: 18/323,712

(22) Filed: May 25, 2023

(30) Foreign Application Priority Data
Dec. 14, 2022 (IN) 202221072350

(51) Int. Cl. G06F 3/04892; G01S 13/06; G06F 3/0485

(52) U.S. Cl. CPC G06F 3/04892; G01S 13/06; G06F 3/0485

(57) ABSTRACT

An apparatus including a processor and an object detector is provided. The object detector detects a position of an object inside a field of view (FOV) of the object detector. The processor splits the FOV into one or more FOV sectors based on one or more options on a display. Further, the processor maps each of the one or more options uniquely to an FOV sector of the one or more FOV sectors. The processor further controls a movement of a pointer on the display to point to an option of the one or more options of which the mapped FOV sector includes the detected position of the object, thereby enabling contactless control of the display.

### BACKGROUND

### Field of the Disclosure

The present disclosure relates generally to electronic circuits, and, more particularly, to a contactless human-machine interface for displays.

### Description of the Related Art

Electronic devices these days offer different types of human-machine interfaces (HMIs), for example, touch-based interfaces, physical buttons, pointing devices, or the like. For performing any action using these HMIs, a user is required to make physical contact with the HMIs, which is undesirable. Therefore, it is desirable to provide a contactless HMI solution for electronic devices.

### BRIEF DESCRIPTION OF THE DRAWINGS

The following detailed description of the embodiments of the present disclosure will be better understood when read in conjunction with the appended drawings. The present disclosure is illustrated by way of example, and not limited by the accompanying figures, in which like references indicate similar elements.

FIG. 1 illustrates a schematic block diagram of a first apparatus coupled to a second apparatus functioning as a contactless human-machine interface (HMI) for the first apparatus, in accordance with an embodiment of the present disclosure;

FIG. 2 illustrates a schematic block diagram of a third apparatus enabled with the contactless HMI, in accordance with another embodiment of the present disclosure;

FIGS. 3A-3F are diagrams that illustrate exemplary scenarios in which a display is manipulated using the contactless HMI, in accordance with an embodiment of the present disclosure;

FIG. 4 is a diagram that illustrates an exemplary arrangement of options on the display, in accordance with an embodiment of the present disclosure; and

FIGS. 5A and 5B, collectively, represent a flowchart that illustrates a method for enabling the contactless HMI for the display, in accordance with an embodiment of the present disclosure.

### DETAILED DESCRIPTION OF EMBODIMENTS

The detailed description of the appended drawings is intended as a description of the embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

In an embodiment of the present disclosure, an apparatus is disclosed. The apparatus may include an object detector and a processor coupled to the object detector. The object detector may be configured to detect a position of an object with respect to the object detector. The processor may be configured to split a field of view (FOV) of the object detector into one or more FOV sectors based on one or more options on a display. The processor may be further configured to map each of the one or more options uniquely to an FOV sector of the one or more FOV sectors. Further, the processor may be configured to control a movement of a pointer on the display to point to a first option of the one or more options of which the mapped FOV sector includes the detected position of the object.

In another embodiment of the present disclosure, a method to enable a contactless human-machine interface (HMI) for a display is disclosed. The method may include detecting, by an object detector of an apparatus, a position of an object with respect to the object detector. The method may further include splitting a field of view (FOV) of the object detector into one or more FOV sectors based on one or more options on the display and mapping each of the one or more options uniquely to an FOV sector of the one or more FOV sectors, by a processor of the apparatus. Further, the method may include controlling, by the processor, a movement of a pointer on the display to point to a first option of the one or more options of which the mapped FOV sector includes the detected position of the object.

In yet another embodiment of the present disclosure, an apparatus including a display, an object detector, and a processor is disclosed. The display may be configured to display one or more options. The object detector may be configured to detect a position of an object with respect to the object detector. The processor may be coupled to the object detector and the display. The processor may be configured to split a field of view (FOV) of the object detector into one or more FOV sectors based on the one or more options and map each of the one or more options uniquely to an FOV sector of the one or more FOV sectors. Further, the processor may be configured to control a movement of a pointer on the display to point to a first option of the one or more options of which the mapped FOV sector includes the detected position of the object.

In some embodiments, the object detector may include at least one of a group consisting of one or more ultra-wideband (UWB) radio detection and ranging (RADAR) transceivers, one or more moving target indication RADAR transceivers, one or more continuous wave RADAR transceivers, one or more frequency modulated wave RADAR transceivers, one or more pulsed RADAR transceivers, and one or more Doppler effect RADAR transceivers.

In some embodiments, the detected position may correspond to a horizontal angle and a vertical angle of the object with respect to the object detector. The FOV may include a horizontal angle range and a vertical angle range of the object detector. To split the FOV into the one or more FOV sectors, the processor may be further configured to split, based on the one or more options, the horizontal angle range into one or more horizontal angle sub-ranges and the vertical angle range into one or more vertical angle sub-ranges. Each FOV sector of the one or more FOV sectors may comprise a unique combination of a horizontal angle sub-range of the one or more horizontal angle sub-ranges and a vertical angle sub-range of the one or more vertical angle sub-ranges.

In some embodiments, the one or more options may be arranged on the display in one or more rows and one or more columns. The processor may split the horizontal angle range into the one or more horizontal angle sub-ranges based on a count of the one or more columns in which the one or more options are arranged on the display. The processor may further split the vertical angle range into the one or more vertical angle sub-ranges based on a count of the one or more rows in which the one or more options are arranged on the display.

In some embodiments, the processor may be further configured to control the movement of the pointer on the display to shift the pointer from the first option to a second option of the one or more options based on a change in the position of the object in at least one of a group consisting of a horizontal plane and a vertical plane.

In some embodiments, the one or more options may include one or more graphical user interface (GUI) elements.

In some embodiments, the one or more options may include at least one of a group consisting of a left scroll option, a right scroll option, an upward scroll option, and a downward scroll option. The processor may be further configured to perform one of a group consisting of a left scroll action on the display when the first option corresponds to the left scroll option, a right scroll action on the display when the first option corresponds to the right scroll option, an upward scroll action on the display when the first option corresponds to the upward scroll option, and a downward scroll action on the display when the first option corresponds to the downward scroll option.

In some embodiments, the object detector may be further configured to initiate the detection of the position of the object based on the object being within a threshold distance from the object detector.

In some embodiments, the object detector may be further configured to initiate the detection of the position of the object based on a time duration for which the object is within the threshold distance, exceeding a threshold time duration.

In some embodiments, the object detector may be further configured to detect a forward movement and a backward movement of the object with respect to the object detector based on a change of distance between the object and the object detector. The forward movement and the backward movement may be detected after the pointer points to the first option. The processor may be further configured to perform a select action for the first option based on the detection of the forward movement and the backward movement within a defined time duration. The object detector may be further configured to select the object from a plurality of objects that are within the FOV of the object detector based on the object being nearest to the object detector among the plurality of objects.

In some embodiments, the apparatus may be a plug-and-play apparatus that interfaces with the display and functions as a contactless HMI for the display.

Conventionally, to avoid physical contact based interfaces for interaction with a user, devices having contactless human-machine interface (HMI) functionality are utilized. Such contactless HMI functionality is typically realized based on gesture recognition systems that detect a predefined gesture made by the user and control an associated functionality of the device. The user may be required to place their hand/face within proximity of the gesture recognition system for accurate detection of the predefined gesture made by the user. Such gesture recognition systems, however, use complex machine-learning algorithms and/or hardware-intensive imaging devices. Additionally, these gesture recognition systems do not offer reliability in varied environmental conditions (e.g., low light conditions, multiple objects in proximity, or the like) and are specifically aimed to detect predefined human gestures (e.g., hand gestures, facial gestures, or the like). As a result, the gesture recognition systems are limited to detecting some specific gestures made using specific object types, thus restricting the use of gesture recognition systems in other scenarios that do not conform to the predefined gesture or object type criteria.

Various embodiments of the present disclosure disclose an apparatus that provides contactless HMI functionality. The apparatus may include an object detector that detects a position of an object. The position of the object may be detected with respect to the object detector. Further, the apparatus may include a processor that is coupled to the object detector. The processor may split a field of view (FOV) of the object detector into FOV sectors based on options on a display. Each option is uniquely mapped to one of the FOV sectors. The processor may further control a movement of a pointer on the display so as to point to one of the options of which the mapped FOV sector includes the detected position of the object.

Thus, the apparatus enables the contactless HMI functionality for controlling the display. The apparatus may be implemented as a plug-and-play solution that can convert any contact-based HMI to the contactless HMI with minimal software updates or may be implemented as an in-built mechanism in a device to provide the contactless HMI functionality. Some embodiments of the apparatus may not require complex gesture recognition systems that use imaging devices. As a result, the working of the apparatus is simplified. Further, the object detector is not limited to identifying any specific object type for facilitating the contactless HMI functionality, which makes the apparatus more user-friendly and easy to use. The object detector, for example, uses a radio detection and ranging (RADAR) mechanism for object identification and position tracking, thus allowing the apparatus to track objects precisely and accurately even in varied environmental conditions (e.g., low light conditions). Additionally, the apparatus overcomes the challenges of contact-based HMI devices (e.g., spreading contact infections).

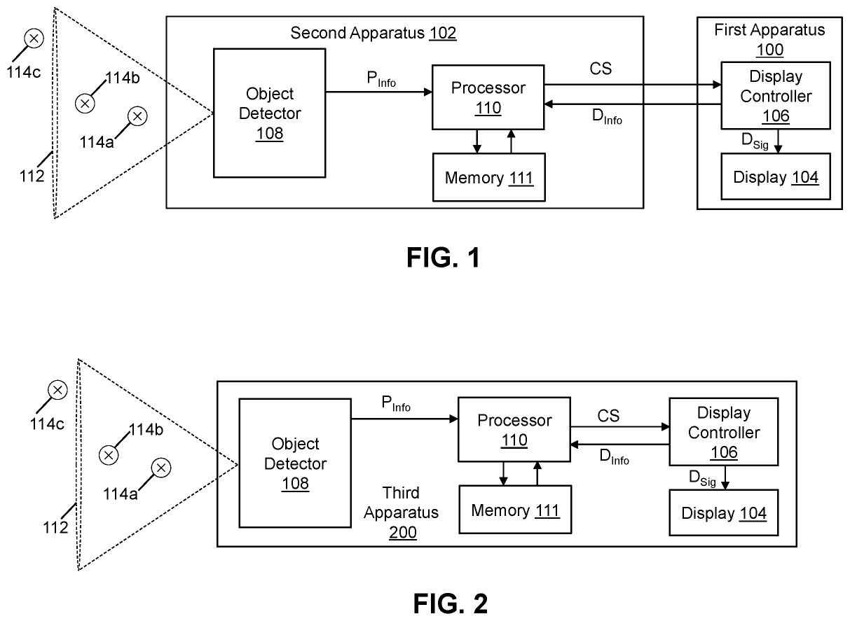

FIG. 1 illustrates a schematic block diagram of a first apparatus 100 coupled to a second apparatus 102 functioning as a contactless human-machine interface (HMI) for the first apparatus 100, in accordance with an embodiment of the present disclosure. Examples of the first apparatus 100 may include, but are not limited to, televisions, smartphones, projectors, laptops, desktops, kiosk machines, or any other apparatus with display capability. The first apparatus 100 may include a display 104 and a display controller 106. The second apparatus 102 may include an object detector 108, a processor 110, and a memory 111.

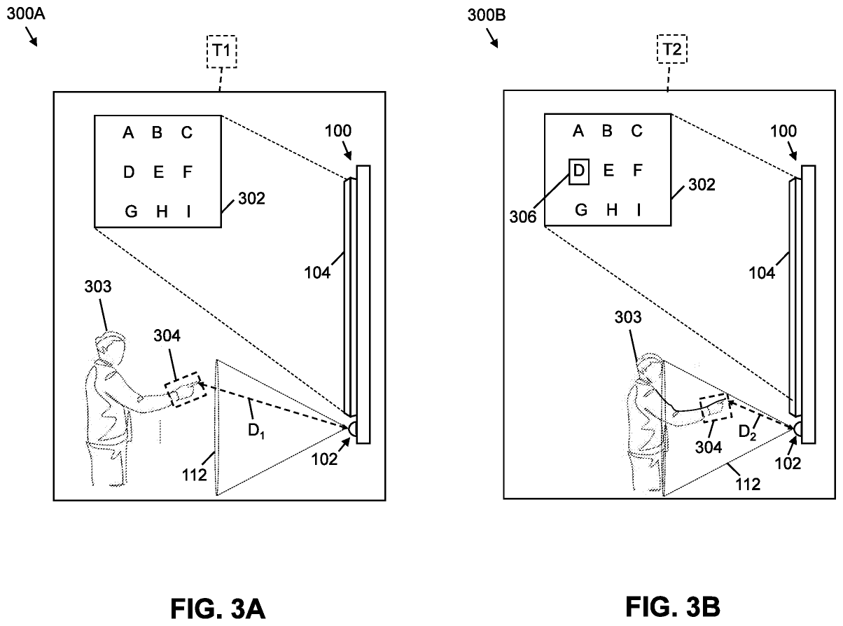

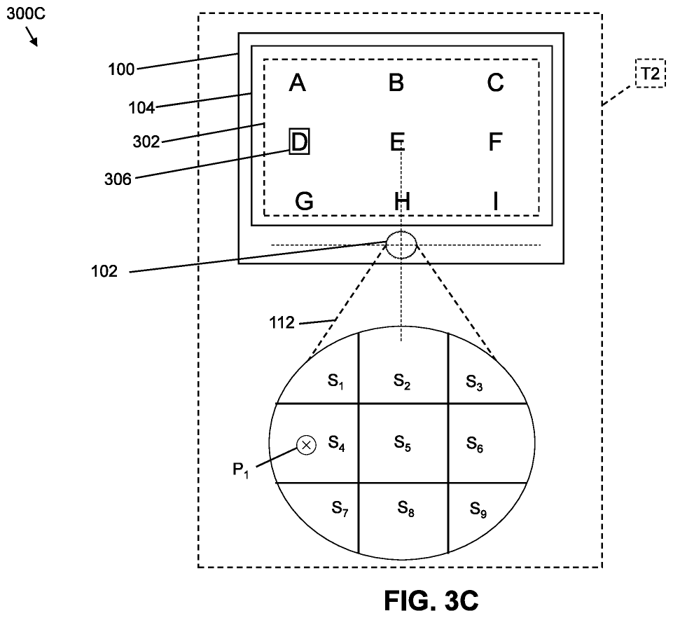

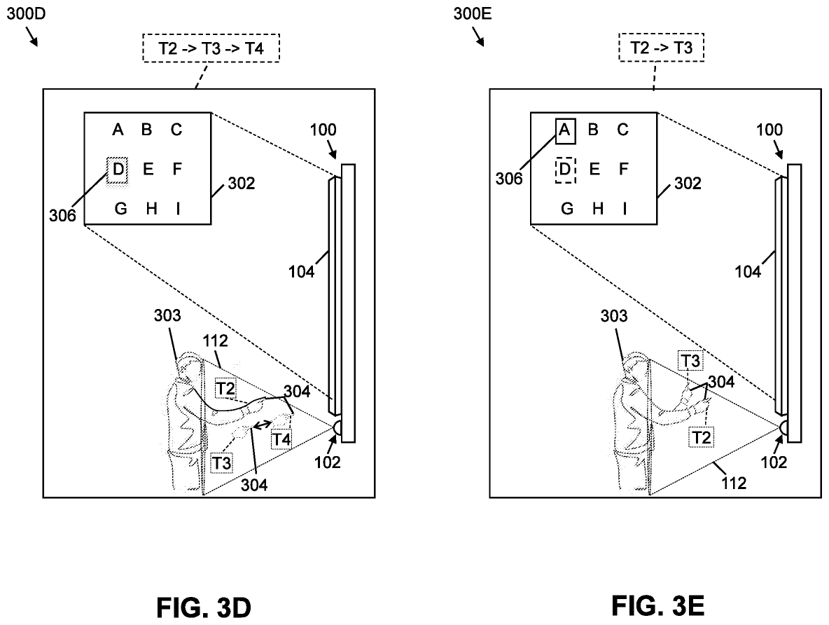

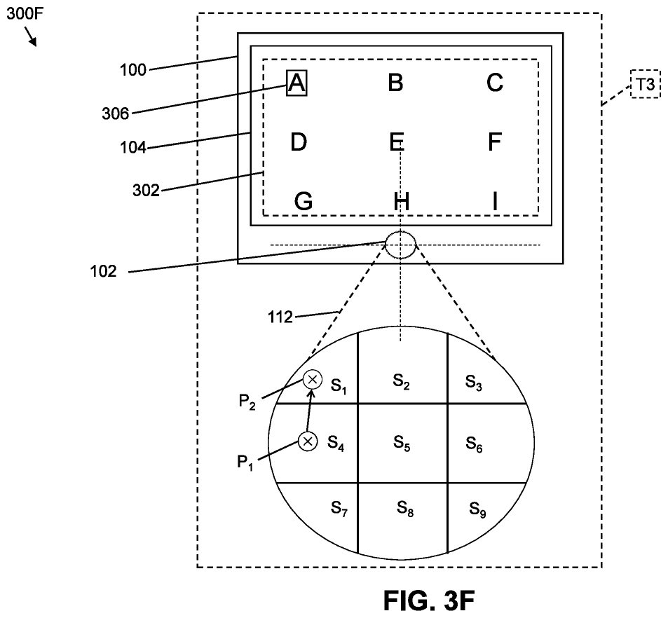

Examples of the display 104 may include, but are not limited to, monochrome or color Liquid Crystal Display (LCD), Organic Light Emitting Diode (OLED), or any other suitable display technology. In an embodiment, the display 104 may be a touchscreen display. The display 104 may be configured to present a user interface (UI) to an end user of the first apparatus 100. The UI and the end user are shown later in FIGS. 3A-3F. The UI may further present various options in the form of graphical user interface (GUI) elements that can be selected by the end user by providing a user input. Examples of the options presented on the UI may include, but are not limited to, icons, uniform resource locator (URL) links, tabs, checkboxes, buttons, scroll options (such as left scroll, right scroll, upward scroll, and downward scroll), or other GUI elements that are selectable by the end user. As a default option, the first apparatus 100 may support various mechanisms to receive the user input, for example, remote control, touchscreen-based control, or the like. In an embodiment, the options (e.g., the GUI elements) may be arranged on the UI in rows and columns. In another embodiment, the options (e.g., the GUI elements) on the UI may be arranged in a random manner and may not follow a specific pattern.

The display controller 106 may be coupled to the display 104. The display controller 106 may include suitable logic, circuitry, and/or interfaces that may be configured to perform various operations for controlling the display 104. The display controller 106 may be configured to generate a drive signal D_{Sig} and provide the drive signal D_{Sig} to the display 104. In an embodiment, the display controller 106 may generate the drive signal D_{Sig} based on the user input of the end user. The drive signal D_{Sig} may control presentation of the UI, manipulation of the various options (e.g., the GUI elements) on the UI, and other functions of the UI.

For the sake of brevity, the first apparatus 100 is only shown to include the display 104 and the display controller 106; however, in an actual implementation, the first apparatus 100 may include any additional component (for example, a microprocessor, a power supply, or the like) for functional requirements.

The second apparatus 102 may be communicatively coupled to the first apparatus 100. As illustrated in FIG. 1, the second apparatus 102 may be a plug-and-play apparatus that is configured to interface with the first apparatus 100 (e.g., the display 104) to enable (or activate) the contactless HMI functionality for the first apparatus 100. The connection between the first apparatus 100 and the second apparatus 102 may be a wired connection or a wireless connection. The second apparatus 102 may implement the contactless HMI functionality for the first apparatus 100 by way of the object detector 108, the processor 110, and the memory 111.

The object detector 108 may include suitable logic, circuitry, and/or interfaces that may be configured to perform various operations for detecting and tracking objects within a field of view (FOV) 112 of the object detector 108. The FOV 112 may correspond to an angular cone perceivable by the object detector 108 at any time instant. In other words, the FOV 112 may represent a sensing range or a detection range of the object detector 108. The FOV 112 may be defined in terms of a horizontal angle range across a horizontal plane and a vertical angle range across a vertical plane. In an embodiment, a plurality of objects, for example, a first object 114a, a second object 114b, and a third object 114c, may be present in the vicinity of the object detector 108.

The object detector 108 may be configured to detect the positions of those objects that are present within the FOV 112. For example, the object detector 108 may be configured to detect the positions of the first object 114a and the second object 114b with respect to the object detector 108 since the first object 114a and the second object 114b are present within the FOV 112. However, the object detector 108 may be unable to detect a position of the third object 114c as the third object 114c is present outside the FOV 112. A position of an object may correspond to a horizontal angle and a vertical angle of the object with respect to the object detector 108. The horizontal angle may be indicative of the position of the object in the horizontal plane and the vertical angle may be indicative of the position of the object in the vertical plane, with respect to the object detector 108.

The object detector 108 may be further configured to select one object in the FOV 112 as a target object for further tracking. In an embodiment, the object detector 108 may be configured to detect a distance of each object in the FOV 112 from the object detector 108 and select one object as the target object that is nearest to the object detector 108 among the objects in the FOV 112.

In an exemplary embodiment, the object detector 108 may include one or more ultra-wideband (UWB) radio detection and ranging (RADAR) transceivers. Each UWB RADAR transceiver may emit a short-range radio signal within the FOV 112. The first object 114a and the second object 114b within the FOV 112 may reflect the short-range radio signals, which are then received by the UWB RADAR transceivers. The object detector 108 may detect the distance of each object (e.g., the first object 114a and the second object 114b) from the object detector 108 based on the reflected short-range radio signals received by the UWB RADAR transceivers. Additionally, the object detector 108 may be configured to detect the position of each object (e.g., the first object 114a and the second object 114b) based on an angle of arrival (AoA) of the reflected short-range radio signals received at the UWB RADAR transceivers. For example, the UWB RADAR transceivers may be arranged in an array and the AoA may be calculated by measuring a time difference in the arrival of the reflected radio signals between individual UWB RADAR transceivers of the array.

In an exemplary embodiment, each UWB RADAR transceiver may emit the short-range radio signal at periodic time intervals when no object is present within the FOV 112 (e.g., for power conservation). However, if the UWB RADAR transceivers detect that an object is present within the FOV 112, the object detector 108 may be configured to determine whether the detected object is present within a threshold distance from the object detector 108. When the object detector 108 determines that the detected object is not present within the threshold distance from the object detector 108, the object detector 108 may continuously emit the radio signals until the object is no longer detected or the object is detected to be present within the threshold distance from the object detector 108. Conversely, when the object detector 108 determines that the object is present within the threshold distance from the object detector 108, the object detector 108 may be configured to detect the position of the object with respect to the object detector 108. Additionally, if the object detector 108 determines multiple objects to be present within the threshold distance from the object detector 108, the object detector 108 may select the nearest object for detecting the position.

In another embodiment, the object detector 108 may be configured to wait for a first threshold time duration to initiate the detection of the position of the object for preventing spurious or unwanted object tracking events, for example, when the end user erroneously places an object within the threshold distance of the object detector 108. In other words, the object detector 108 may initiate the detection of the position of the selected object when the time duration for which the object is within the threshold distance exceeds the first threshold time duration.

In an embodiment, the threshold distance of the object detector 108 may depend upon a position, a size, a type, a count, or like, of the UWB RADAR transceivers used in the object detector 108. In another embodiment, the threshold distance may be a configurable parameter for the end user to select. For example, the end user may configure the threshold distance to be anywhere between a maximum distance value and a minimum distance value supported by the UWB RADAR transceivers used in the object detector 108.

The object detector 108 may be further configured to provide position information P_{info} indicating the detected position (e.g., the horizontal angle and the vertical angle) of the selected object to the processor 110. Since the object detector 108 may continuously track (or detect) the position of the selected object, the position information P_{info} provided to the processor 110 may indicate real-time or near real-time changes in the position of the selected object. The position information P_{info} may further indicate a distance of the selected object from the object detector 108.

In an embodiment, the object detector 108 may be further configured to detect a forward movement and a backward movement of the selected object with respect to the object detector 108 based on a change of distance between the selected object and the object detector 108. In an example, the selected object may be moved in a forward direction and then in a backward direction or in the backward direction and then in the forward direction. In such a scenario, due to the change in the distance between the selected object and the object detector 108, the object detector 108 may detect that the selected object has been moved in a to-and-fro manner.

The position information P_{info} may further indicate a temporal sequence of the distance of the selected object from the object detector 108. The temporal sequence may include a time-series of distance values of the selected object from the object detector 108. Thus, when the selected object is moved in the forward direction and then in the backward direction or in the backward direction and then in the forward direction, the position information P_{info} is indicative of the to-and-fro motion of the selected object.

Although it is described that the object detector 108 may include one or more UWB RADAR transceivers, the scope of the present disclosure is not limited to it. In other embodiments, different transceivers may be utilized to implement the object detector 108, without deviating from the scope of the present disclosure. Examples of such transceivers may include, but are not limited to, moving target indication RADAR transceivers, continuous wave RADAR transceivers, frequency modulated wave RADAR transceivers, pulsed RADAR transceivers, Doppler effect RADAR transceivers, or the like.

The processor 110 may be communicatively coupled to the object detector 108. In an embodiment, the processor 110 and the object detector 108 may be included in a single housing and the processor 110 may be coupled to the object detector 108 by way of a wired connection. In another embodiment, the second apparatus 102 may include two separate housings, one for the object detector 108 and another for the processor 110. In such an embodiment, the processor 110 may be coupled to the object detector 108 by way of a wired connection or a wireless connection.

The processor 110 may include suitable logic, circuitry, and/or interface that may be configured to perform various operations to implement the contactless HMI functionality for the first apparatus 100. The processor 110 may be configured to receive display information D_{info} from the display controller 106. The display information D_{info} may indicate the options (e.g., the GUI elements) presented on the UI of the display 104. In an embodiment, the display information D_{info} may further indicate a spatial arrangement of the options (e.g., the GUI elements) on the UI. For example, if the options are arranged in rows and columns, the display information D_{info} may indicate a row number and a column number of each option. In another example, the display information D_{info} may further indicate pixel numbers of pixels occupied by each option on the UI of the display 104. In other words, the display information D_{info} enables the processor 110 to determine a position of each option on the UI of the display 104.

The processor 110 may be further configured to split the FOV 112 of the object detector 108 into different FOV sectors (shown later in FIGS. 3C and 3F) based on the options on the display 104. To split the FOV 112 into the FOV sectors, the processor 110 may be configured to split the horizontal angle range of the FOV 112 into one or more horizontal angle sub-ranges and the vertical angle range of the FOV 112 into one or more vertical angle sub-ranges based on the options indicated by the display information D_{info}. A horizontal angle sub-range may correspond to a subset of the horizontal angle range and a vertical angle sub-range may correspond to a subset of the vertical angle range. In an embodiment, where the options on the display 104 are arranged in one or more rows and one or more columns, the processor 110 may split the horizontal angle range into the one or more horizontal angle sub-ranges based on a count of the one or more columns in which the options are arranged on the display 104 and the vertical angle range into the one or more vertical angle sub-ranges based on a count of the one or more rows in which the options are arranged on the display 104.

In an example, six options (e.g., GUI elements) may be arranged in two rows and three columns on the UI of the display 104. In such a scenario, the processor 110 may split a horizontal angle range of 0°-180° into three horizontal angle sub-ranges of 0°-60°, 61°-120°, and 121°-180°, and a vertical angle range of 0°-90° into two vertical angle sub-ranges of 0°-45° and 46°-90° for splitting the FOV 112 to six FOV sectors corresponding to the six options. In such a scenario, each FOV sector may include a unique combination of a horizontal angle sub-range and a vertical angle sub-range. For example, a first FOV sector may comprise a horizontal angle sub-range of 0°-60° and a vertical angle sub-range of 0°-45° and a second FOV sector may comprise a horizontal angle sub-range of 0°-60° and a vertical angle sub-range of 46°-90°.

The processor 110 may be further configured to map each option (e.g., the GUI elements) uniquely to one FOV sector of the FOV sectors. In an embodiment, the processor 110 may map the options to the FOV sectors in accordance with the positional arrangement of the options on the display 104 and a spatial location of the FOV sectors. For example, the top left option may be mapped to the top left FOV sector and the top right option may be mapped to the right FOV sector. Upon mapping, each option on the display 104 gets uniquely associated with a horizontal angle sub-range and a vertical angle sub-range of the mapped FOV sector. In an embodiment, the processor 110 may be configured to store the information pertaining to the mapping of the options (e.g., the GUI elements) and the FOV sectors in the memory 111.

The processor 110 may be further configured to control a movement of a pointer (shown later in FIGS. 3B-3F) on the display 104 to point to an option of which the mapped FOV sector includes the detected position of the selected object. The processor 110 may further control the movement of the pointer on the display 104 to shift the pointer from one option to another option based on a change in the position of the selected object in either the horizontal plane or the vertical plane. For example, the processor 110 may control the movement of the pointer to point to a first option corresponding to a first position of the selected object. However, the object may be moved from the first position to a second position so as to point the pointer to another option. In such a scenario, the position information P_{info} received from the object detector 108 may indicate a change in the position of the selected object. Based on the changed position indicated by the position information P_{info}, the processor 110 may further control the movement of the pointer to point to the second option of which the mapped FOV sector includes the second position.

The processor 110 may be further configured to perform a select action for the option pointed to by the pointer on the display 104 based on the detection of the forward movement and the backward movement of the selected object within a defined time duration after the pointer points to the option on the display 104. Examples of the defined time duration may include 3 seconds, 5 seconds, or the like. When the position information P_{info} indicates that the selected object has been moved to-and-fro after the pointer points to one of the presented options on the display 104, with the to-and-fro movement being executed within the defined time duration, the processor 110 may perform the select action to select the option pointed to by the pointer on the display 104. The select action may result in an operation associated with the selected option. The processor 110 may refer to the temporal sequence in the position information P_{info} to determine whether the to-and-fro movement of the selected object was executed within the defined time duration. In a scenario where the processor 110 detects that the to-and-fro movement of the object was not executed within the defined time duration (for example, where the time taken to move the object in the forward and the backward directions exceeds the defined time duration), the processor 110 does not perform the select action. In an embodiment, the defined time duration may be a configurable parameter. For example, in an embodiment, the end user may define the defined time duration during the setup of the second apparatus 102.

The processor 110 may be further configured to generate and transmit a control signal CS to the display controller 106 to indicate a control operation for the display 104. The control signal CS is generated to control the movement of the pointer on the display 104 and to control performing the select action. The drive signal D_{sig} is generated by the display controller 106 based on the control signal CS, which may result in the control operation for the display 104. Thus, by the use of the second apparatus 102 with the first apparatus 100, the end user can provide the user input in a contactless manner without relying on the default mechanism of the first apparatus 100.

In an embodiment, any change in the options presented on the UI of the display 104 may cause the display controller 106 to provide updated display information D_{info} to the processor 110, which in turn may cause the processor 110 to split the FOV 112 into new FOV sectors corresponding to the changed options and map the new FOV sectors to the changed options. Further, the processor 110 may update the mapping information stored in the memory 111 to reflect the change in the mapping.

In an embodiment, a format of the control signal CS generated by the processor 110 may depend on configuration requirement of the first apparatus 100. In other words, the processor 110 may generate the control signal CS in a format supported by the first apparatus 100. In an embodiment, the compatibility information may be shared between the first apparatus 100 and the second apparatus 102 when the connection is set up therebetween. The processor 110 may be capable of changing the format of the control signal CS based on a detected type of the first apparatus 100. In another embodiment, the display controller 106 may be reconfigured by means of a program update (e.g., software update, firmware update, or the like) to interpret the control signal CS transmitted by the processor 110.

The memory 111 may include suitable logic, circuitry, and interfaces that may be configured to store the information pertaining to the mapping of the options (e.g., the GUI elements) and the FOV sectors. The information may be updated by the processor 110 based on any change in the displayed options on the display 104. Examples of the memory 111 may include, but are not limited to, a random access memory (RAM), a read-only memory (ROM), a removable storage drive, a hard disk drive (HDD), a flash memory, a solid-state memory, or the like. It will be apparent to a person skilled in the art that the scope of the disclosure is not limited to realizing the memory 111 as a standalone component, as described herein. In another embodiment, the memory 111 may be the in-built memory of the processor 110, without departing from the scope of the present disclosure.

FIG. 2 illustrates a schematic block diagram of a third apparatus 200 enabled with the contactless HMI, in accordance with another embodiment of the present disclosure. The third apparatus 200 may include the display 104, the display controller 106, the object detector 108, the processor 110, and the memory 111. Operations of the display 104, the display controller 106, the object detector 108, the processor 110, and the memory 111 are the same as described in the foregoing description of FIG. 1. As illustrated in FIG. 2, instead of using the plug-and-play apparatus 102 for enabling the contactless HMI functionality, the third apparatus 200 has the contactless HMI functionality as an input mechanism inbuilt therein.

FIGS. 3A-3F are diagrams that illustrate exemplary scenarios 300A-300F in which the display 104 is manipulated using the contactless HMI, in accordance with an embodiment of the present disclosure. For the sake of ongoing description, the exemplary scenarios 300A-300F are described in conjunction with the first apparatus 100 and the second apparatus 102. However, the third apparatus 200 can also be used to execute the exemplary scenarios 300A-300F, without deviating from the scope of the present disclosure.

In the exemplary scenario 300A with regards to FIG. 3A, the second apparatus 102 is shown to have been communicatively coupled to the first apparatus 100 for enabling the contactless HMI functionality for the first apparatus 100. The first apparatus 100 is shown to have been powered on with the display 104 displaying the UI (hereinafter referred to and designated as the “UI 302”). The UI 302 is shown to display (e.g., present) nine options ‘A’, ‘B’, ‘C’, ‘D’, ‘E’, ‘F’, ‘G’, ‘H’, and ‘I’ arranged in three rows and three columns. These nine options are selectable GUI elements. Though in the exemplary scenario 300A, the second apparatus 102 is shown to have been placed below the display 104, the scope of the disclosure is not limited to it.

The display controller 106 in the first apparatus 100 may transmit the display information D_{info} indicating the nine options (e.g., ‘A’, ‘B’, ‘C’, ‘D’, ‘E’, ‘F’, ‘G’, ‘H’, and ‘I’) presented on the UI 302 of the display 104 to the processor 110. The display information D_{info} may further indicate that the nine options are arranged in three rows and three columns along with indicating the row number and the column number of each of the nine options. In an embodiment, the display information D_{info} may further indicate pixel numbers of the pixels occupied by each of the nine options on the UI 302 of the display 104. Based on the options indicated in the display information D_{info}, the processor 110 may split the FOV 112 of the object detector 108 into different FOV sectors (e.g., nine FOV sectors as shown in FIG. 3C). Splitting of the FOV 112 into nine FOV sectors may include splitting the horizontal angle range of the FOV 112 into three horizontal angle sub-ranges and the vertical angle range of the FOV 112 into three vertical angle sub-ranges. The processor 110 may then map the nine options uniquely to the FOV sectors. In an embodiment, the horizontal angle range and the vertical angle range may be split uniformly across the FOV sectors. In another embodiment, the horizontal angle range and the vertical angle range may be split across the FOV sectors in accordance with the count of pixels occupied by each option on the display 104.

With regards to FIG. 3C, the FOV 112 is shown to have been uniformly split into nine FOV sectors, for example, FOV sectors ‘S₁’, ‘S₂’, ‘S₃’, ‘S₄’, ‘S₅’, ‘S₆’, ‘S₇’, ‘S₈’, and ‘S₉’. Further, FOV sectors ‘S₁’, ‘S₂’, ‘S₃’, ‘S₄’, ‘S₅’, ‘S₆’, ‘S₇’, ‘S₈’, and ‘S₉’ are mapped to the options ‘A’, ‘B’, ‘C’, ‘D’, ‘E’, ‘F’, ‘G’, ‘H’, and ‘I’, respectively, by the processor 110. The mapping information is then stored by the processor 110 in the memory 111 of the second apparatus 102.

Referring back to FIG. 3A, at time instance T1, the end user (hereinafter referred to and designated as the “end user 303”) attempts to provide a user input by using their hand as an object 304 for controlling the HMI. In an exemplary embodiment, the object 304 may correspond to the first object 114a of FIGS. 1 and 2. As shown in the exemplary scenario 300A, the hand of the end user 303 is present at a distance D₁ from the second apparatus 102, which is outside the FOV 112. As a result, the object detector 108 is unable to detect the hand of the end user 303 as a target object for controlling the display 104. Hereinafter, the terms “the hand of the end user 303” and “the object 304” have been used interchangeably without deviating from the scope of the disclosure.

Though in the exemplary scenario 300A the hand of the end user 303 is used as an object for controlling the display 104, the scope of the disclosure is not limited to it. The end user 303 may use any object irrespective of its shape, size, make, color, or the like, for controlling the display 104, without deviating from the scope of the present disclosure. For example, the end user 303 may use a pen, a book, a ball, or the like, as an object for controlling the display 104. In other words, the second apparatus 102 is independent of a type of object, thereby improving the case of use, especially for differently-abled persons.

In the exemplary scenario 300B with regards to FIG. 3B, the end user 303 is shown to have moved closer to the second apparatus 102 such that the hand of the end user 303 is now within the FOV 112 and at a distance D₂ from the second apparatus 102. In such a scenario, the radio signals emitted by the object detector 108 are reflected by the object 304 and one or more other objects such as the arm of the end user 303. The object detector 108 may receive the reflected radio signals and may determine the distance of each object from the object detector 108. For example, the object detector 108 may determine the distance of the object 304 (e.g., the hand of the end user 303) and the arm of the end user 303 from the object detector 108. Based on the determined distance, the object detector 108 may further determine whether any object is present within the threshold distance from the object detector 108.

In a non-limiting example, it is assumed that the hand and the arm of the end user 303 are determined to be present within the threshold distance from the object detector 108. In such a scenario where multiple objects are present within the threshold distance, the object detector 108 may select the nearest object among the detected objects as the target object. In the exemplary scenario 300B, the object detector 108 may select the hand of the end user 303 (e.g., the object 304) as the target object for further tracking.

The object detector 108 may further determine whether the object 304 has been within the threshold distance for at least the first threshold time duration (e.g., 2 seconds, 3 seconds, or the like). The object detector 108 may then initiate the detection of the position of the object 304 based on the object 304 being within the threshold distance from the object detector 108 for more than the first threshold time duration. At time instance T2, the object 304 may be detected at a position ‘P₁’ having a horizontal angle ‘H₁’ and a vertical angle ‘V₁’ with respect to the object detector 108. The object detector 108 may then provide the position information P_{info} of the object 304 to the processor 110. The position information P_{info} may indicate the time-series of distance values of the object 304 and position values corresponding to each distance value.

The processor 110 may then identify which of the FOV sectors ‘S₁’, ‘S₂’, ‘S₃’, ‘S₄’, ‘S₅’, ‘S₆’, ‘S₇’, ‘S₈’, and ‘S₉’ corresponds to the horizontal angle sub-range and the vertical angle sub-range that include the horizontal angle ‘H₁’ and the vertical angle ‘V₁’ of the position ‘P₁’. Upon identifying the FOV sector that includes the position ‘P₁’, the processor 110 may generate the control signal CS to indicate a control operation for the display 104. The control signal CS may be generated so as to control a movement of the pointer (hereinafter referred to and designated as the “pointer 306”) on the display 104 to point to an option among the options ‘A’, ‘B’, ‘C’, ‘D’, ‘E’, ‘F’, ‘G’, ‘H’, and ‘I’ of which the mapped FOV sector includes the position ‘P₁’. The processor 110 may then provide the control signal CS to the display controller 106 in the first apparatus 100 and the display controller 106 may generate and provide the drive signal D_{Sig} to the display 104 to navigate the pointer 306 to point to the option of which the mapped FOV sector includes the position ‘P₁’.

Referring now to FIG. 3C, the exemplary scenario 300C illustrates that the position ‘P₁’ is included in the FOV sector ‘S₄’. Therefore, at time instance T2 when the selected object 304 is at the position ‘P₁’, the processor 110 identifies the FOV sector ‘S₄’. The processor 110 then generates the control signal CS so as to control the pointer 306 to point to the option ‘D’ mapped to the FOV sector ‘S₄’ including the position ‘P₁’. In response to the control signal CS, the display 104 is controlled and the pointer 306 is shown to point to the option ‘D’.

Referring back to FIG. 3B, at time instance T2, the pointer 306 may merely point to the option ‘D’ without the option ‘D’ being selected for further operation. Typically, the end user 303 is required to submit a select input after navigating the pointer 306 to point to the desired option. FIG. 3D illustrates the exemplary scenario 300D in which the end user 303 provides a select input in a contactless manner for option ‘D’. FIGS. 3E and 3F illustrate exemplary scenarios 300E and 300F in which the end user 303, instead of providing the select input for option ‘D’, provides an input to navigate the pointer 306 to point to another option.

Referring now to FIG. 3D, the exemplary scenario 300D illustrates a to-and-fro movement of the object 304. At time instance T3, the end user 303 may move the object 304 (e.g., the hand of the end user 303) in a backward direction with respect to the second apparatus 102, and then at time instance T4, the end user 303 may move the object 304 in a forward direction with respect to the second apparatus 102. For the sake of brevity, it is assumed that at time instances T3 and T4, the object 304 maintains the same horizontal angle ‘H₁’ and the vertical angle ‘V₁’ with respect to the object detector 108 and merely moves the object 304 to and fro.

The object detector 108 may detect the backward movement and the forward movement of the object 304 with respect to the object detector 108 based on a change of distance between the object 304 and the object detector 108. The forward movement and the backward movement are detected after the pointer 306 points to the option ‘D’ at time instance T2. Upon detection of the forward movement and the backward movement by the object 304, the object detector 108 may transmit new positional information P_{info} to the processor 110 indicative of the time-series of distance values of the object 304 from the object detector 108.

The processor 110 may identify the to-and-fro movement of the object 304 based on the new positional information P_{info}. The processor 110 may further determine whether the to-and-fro movement of the object 304 was completed within the defined time duration after the pointer 306 points to the option ‘D’. For example, the processor 110 may determine a time elapsed between time instances T2 and T4 to determine the time taken to complete the to-and-fro movement of the object 304. In a scenario, when the time elapsed during the to-and-fro movement of the object 304 exceeds the defined time duration, the processor 110 may discard the user input indicated by the to-and-fro movement of the object 304. However, when the processor 110 determines that the time elapsed during the to-and-fro movement of the object 304 is less than or equal to the defined time duration, the processor 110 may generate another control signal CS and provide to the display controller 106 to perform a select action for the option ‘D’. The display controller 106 upon receiving the control signal CS may generate the drive signal D_{Sig} that results in the selection of the option ‘D’. The shadowed pointer 306 in FIG. 3D indicates that the option ‘D’ is selected. Though not shown, the selection of the option ‘D’ may result in the operation linked to the option ‘D’ being executed, without deviating from the scope of the present disclosure.

Though the end user 303 is shown to move the object 304 first in the backward direction and then in the forward direction to perform the select action, the scope of the disclosure is not limited to it. In another embodiment, the end user 303 may move the object 304 in the forward direction and then in the backward direction to perform the select action, without deviating from the scope of the disclosure.

In an embodiment, a subpage may additionally open on the UI 302 in response to the select action performed on the option ‘D’. In such a scenario, the display controller 106 may transmit new display information D_{info} to the processor 110 indicating a change in the UI 302. The processor 110 may split the FOV 112 into new FOV sectors in accordance with the new display information D_{info} and map the newly presented options uniquely to the new FOV sectors for further controlling the display 104.

Referring now to FIG. 3E, in the exemplary scenario 300E, the end user 303 is shown to have moved their hand (for example, the object 304) from the position ‘P₁’ to a new position ‘P₂’ such that the horizontal angle ‘H₁’ changes to a horizontal angle ‘H₂’ and the vertical angle ‘V₁’ changes to ‘V₂’. In other words, during a time interval between T2 and T3, the position of the object 304 changes from ‘P₁’ to ‘P₂’.

The object detector 108 may detect the change in the position of the object 304 and may transmit new positional information P_{info}, indicative of the time-series of distance values and corresponding position values of the object 304, to the processor 110. The processor 110 may then identify which of the FOV sectors ‘S₁’, ‘S₂’, ‘S₃’, ‘S₄’, ‘S₅’, ‘S₆’, ‘S₇’, ‘S₈’, and ‘S₉’ corresponds to the horizontal angle sub-range and the vertical angle sub-range that include the horizontal angle ‘H₂’ and the vertical angle ‘V₂’ of the new position ‘P₂’, respectively. Upon identifying the FOV sector that includes the position ‘P₂’, the processor 110 may generate another control signal CS to control a movement of the pointer 306 to point to another option among the options ‘A’, ‘B’, ‘C’, ‘D’, ‘E’, ‘F’, ‘G’, ‘H’, and ‘I’ of which the mapped FOV sector includes the position ‘P₂’. The processor 110 may then provide the control signal CS to the display controller 106 and the display controller 106 may generate and provide the drive signal D_{Sig} to the display 104 to navigate the pointer 306 from the option ‘D’ to point to the other option (e.g., the option ‘A’) of which the mapped FOV sector includes the position ‘P₂’.

Referring now to FIG. 3F, the exemplary scenario 300F illustrates that the position ‘P₁’ of the object 304 is changed to the position ‘P₂’. The position ‘P₂’ is included in the FOV sector ‘S₁’. Therefore, at time instance T3, when the selected object 304 is at the position ‘P₂’, the processor 110 identifies the FOV sector ‘S₁’. Further, the processor 110 generates the control signal CS to control the movement of the pointer 306 on the display 104 and to shift the pointer 306 from the option ‘D’ to the option ‘A’ that is mapped to the FOV sector ‘S₁’ including the position ‘P₂’. In other words, in response to a change in the position of the object 304 in the horizontal plane and/or the vertical plane, the processor 110 controls the movement of the pointer 306 to shift the pointer 306 from the old option to a new option corresponding to the new position ‘P₂’. In response to the control signal CS, the display 104 is controlled and the pointer 306 is shown to point to the option ‘A’ at time instance T3.

In an embodiment, the object detector 108 may provide subsequent position information P_{info} regarding the object 304 to the processor 110 upon detecting a change in the position of the object 304. For example, after the initial position detection, the object 304 may remain stationary for a substantial time duration. In such a scenario, the object detector 108 may provide the position information P_{info} upon the initial position detection; however, as the position of the object 304 does not change for a considerable time duration, the object detector 108 may prevent providing the same position information P_{info}. The object detector 108 may wait till any change in the position of the object 304 is detected. Such implementation may take into account the intent of the end user 303 to control the display 104. No change in the position of the object 304 for a considerable time duration may indicate a lack of intent of the end user 303 to control the display 104.

Though the second apparatus 102 is shown to include a single object detector 108, the scope of the present disclosure is not limited to it. In another embodiment, the second apparatus 102 may include multiple object detectors. Such object detectors can be placed at different orientations with respect to the display 104 so as to facilitate enhanced object detection and display control. In an exemplary scenario, the display 104 may have multiple options arranged thereon, for example, 324 options arranged in 18 rows and 18 columns. In such a scenario, an FOV sector mapped to each option may be so small that a minor change in the position of the selected object can result in another option being pointed to by the pointer 306. In order to avoid such scenarios and improve the user experience of the contactless HMI, multiple object detectors may be used, where each object detector is mapped to a subset of the options instead of being mapped to all the presented options. In such a scenario, the UI on the display may be split into different sections each being controlled by one of the object detectors.

In another embodiment, the object detector 108 may include multiple RADAR transceivers which may be selectively enabled or disabled based on a complexity of the UI 302 (for example, a number of options on the UI 302) and a display size of the display 104. For example, a count of RADAR transceivers that are to be enabled may increase with an increase in a display size or an increase in the number of options presented on the display 104.

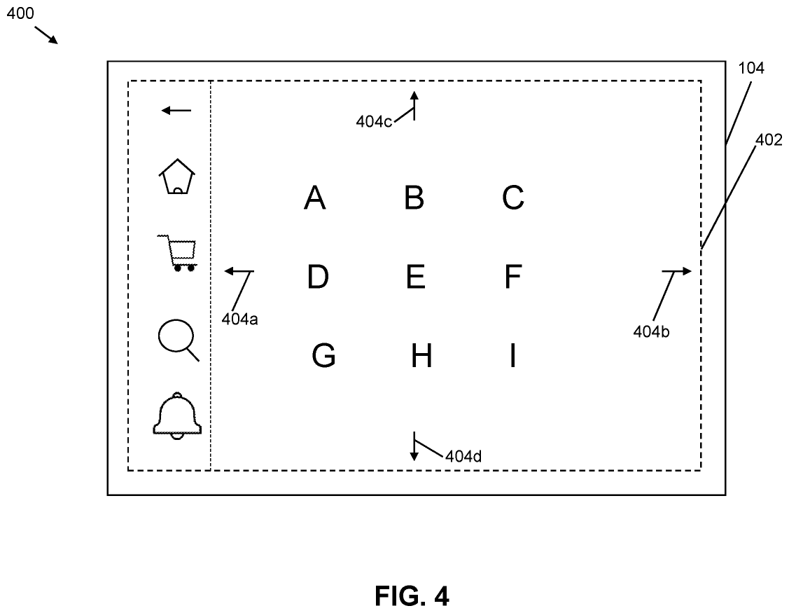

FIG. 4 is a diagram 400 that illustrates an exemplary arrangement of options on the display 104, in accordance with an exemplary embodiment of the present disclosure. In FIG. 4, a UI 402 is shown to be presented on the display 104. The UI 402 has various options, for example, a left scroll option 404a, a right scroll option 404b, an upward scroll option 404c, a downward scroll option 404d, and other GUI elements. The processor 110 may be configured to perform a left scroll action on the UI 402 of the display 104 when the left scroll option 404a is selected and a right scroll action on the UI 402 when the right scroll option 404b is selected, by the end user 303. Similarly, the processor 110 may be configured to perform an upward scroll action on the UI 402 when the upward scroll option 404c is selected and a downward scroll action on the UI 402 when the downward scroll option 404d is selected, by the end user 303. Though the UI 402 is shown to explicitly display the left scroll option 404a, the right scroll option 404b, the upward scroll option 404c, and the downward scroll option 404d as GUI elements, the scope of the disclosure is not limited to it. In another embodiment, the UI 402 may have areas demarcated for the upward scroll option, the downward scroll option, the left scroll option, and the right scroll option without explicitly displaying the left scroll option 404a, the right scroll option 404b, the upward scroll option 404c, and the downward scroll option 404d.

The options presented on the UI 402 may not conform to an arrangement in rows and columns. In such a scenario, the processor 110 may spit the FOV 112 in FOV sectors in accordance with the number of pixels and a position of the pixels occupied by each option on the UI 402.

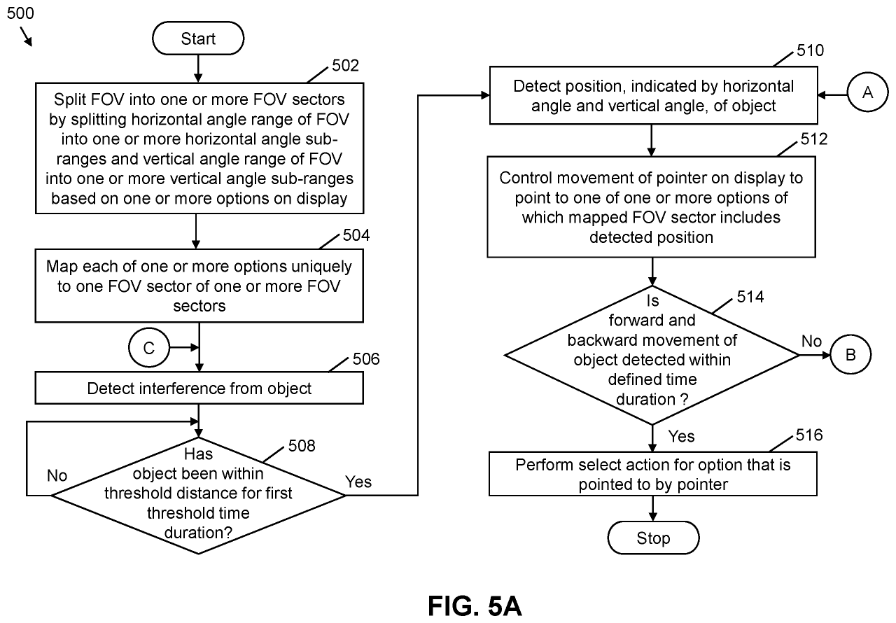

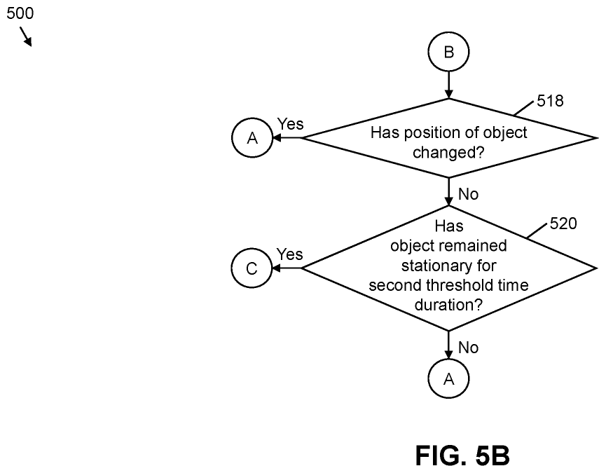

FIGS. 5A and 5B, collectively, represent a flowchart 500 that illustrates a method for enabling the contactless HMI for the display 104, in accordance with an embodiment of the present disclosure.

Referring to FIG. 5A, at step 502, the FOV 112 of the object detector 108 is split into one or more FOV sectors (e.g., sectors S₁’, ‘S₂’, ‘S₃’, ‘S₄’, ‘S₅’, ‘S₆’, ‘S₇’, ‘S₈’, and ‘S₉ shown in FIGS. 3C and 3F) based on one or more options (e.g., ‘A’, ‘B’, ‘C’, ‘D’, ‘E’, ‘F’, ‘G’, ‘H’, and ‘I’) on the display 104. The FOV 112 is split into the FOV sectors by splitting the horizontal angle range of the FOV 112 into the one or more horizontal angle sub-ranges and the vertical angle range of the FOV 112 into the one or more vertical angle sub-ranges, based on the options on the display 104. The processor 110 may split the FOV 112 into the FOV sectors such that each FOV sector comprises a unique combination of a horizontal angle sub-range and a vertical angle sub-range. In an embodiment, the processor 110 may split the horizontal angle range into the one or more horizontal angle sub-ranges based on a count of the columns in which the options are arranged on the display 104. Further, the processor 110 may split the vertical angle range into the one or more vertical angle sub-ranges based on a count of the rows in which the options are arranged on the display 104, as described in the foregoing descriptions of FIGS. 1 and 3A-3F.

At step 504, each of the one or more options is mapped uniquely to one FOV sector of the one or more FOV sectors. The processor 110 may map each of the one or more options on the display 104 uniquely to one FOV sector of the one or more FOV sectors. In other words, each option is uniquely mapped to a horizontal angle sub-range of the one or more horizontal angle sub-ranges and a vertical angle sub-range of the one or more vertical angle sub-ranges based on the mapping between FOV sectors and the options.

At step 506, interference from the object 304 is detected. The object detector 108 may detect interference from the object 304 when the object 304 is present within the FOV 112 of the object detector 108. At step 508, the object detector 108 may determine whether the object 304 has been within the threshold distance of the object detector 108 for the first threshold time duration. If at step 508, the object detector 108 determines that the object 304 has not been within the threshold distance for at least the first threshold time duration, the object detector 108 may wait until the object 304 satisfies both the threshold distance and the first threshold time duration conditions. If at step 508, the object detector 108 determines that the object 304 has been within the threshold distance of the object detector 108 for the first threshold time duration, step 510 is performed.

At step 510, the position of the object 304 is detected. The object detector 108 may detect the position of the object 304 with respect to the object detector 108. The position is indicated by a horizontal angle and a vertical angle. The object detector 108 may transmit the position information P_{info} indicating the detected position of the object 304 to the processor 110. At step 512, a movement of the pointer 306 on the display 104 is controlled to point to one of the one or more options of which the mapped FOV sector includes the detected position. The processor 110 may control the movement of the pointer 306 on the display 104 to point to one of the options of which the mapped horizontal angle sub-range and the mapped vertical angle sub-range includes the horizontal angle and the vertical angle of the object 304, respectively.

At step 514, the object detector 108 may determine whether the forward movement and the backward movement of the object 304 are detected within the defined time duration. If at step 514, the object detector 108 determines that the forward movement and the backward movement of the object 304 are detected within the defined time duration, step 516 is performed. At step 516, a select action for the option that the pointer 306 is pointing to is performed based on the detection of the forward movement and the backward movement within the defined time duration. The processor 110 may transmit the control signal CS to the display controller 106 to perform the select action for the option that is pointed to by the pointer 306 on the display 104. If at step 514, the processor 110 determines that the forward movement and the backward movement of the object 304 are not detected within the defined time duration, step 518 (shown in FIG. 5B) is performed.

Referring now to FIG. 5B, at step 518, the object detector 108 may determine whether the position of the object 304 has changed. If at step 518, the object detector 108 determines that the position of the object 304 has changed, step 510 is performed. However, if at step 518, the object detector 108 determines that the position of the object 304 has not changed, step 520 is performed. At step 520, the object detector 108 may determine whether the object 304 has remained stationary for a second threshold time duration (e.g., 30 seconds, 45 seconds, 1 minute, 2 minutes, or the like). If at step 520, the object detector 108 determines that the object 304 has not remained stationary for the second threshold time duration, step 510 is performed where the new position of the object 304 is detected. However, if at step 520, the object detector 108 determines that the object 304 has remained stationary for the second threshold time duration, step 506 is performed where the object detector 108 waits to detect interference from a new object. Such control enables the object detector 108 to derive the intent of the end user 303. For example, if the selected object 304 remains stationary for the second threshold time duration, the object detector 108 may derive that the end user 303 does not intend to use the object 304 for controlling the display 104 and has merely placed the object 304 within the FOV 112 of the object detector 108.

The flowchart 500 may be implemented again when the UI 302 on the display 104 is updated or changed to present different options than the previous UI. For example, when the select action is performed for an option, the UI 302 may be updated to present a pop-up window with more options to select from. In such a scenario, the flowchart 500 may be implemented again for the updated UI. In other words, the display controller 106 transmits the display information D_{info} to the processor 110 upon any change in the UI 302 of the display 104 and the flowchart 500 is implemented again.

Thus, the apparatus (e.g., the second apparatus 102 or the third apparatus 200) enables the contactless HMI functionality for controlling a display (e.g., the display 104). In an embodiment, the apparatus may be implemented as a plug-and-play solution that can convert contact-based HMI to contactless HMI with minimal software updates. In another embodiment, the apparatus may be implemented as an in-built mechanism in a device to provide contactless HMI functionality. The apparatus does not require any imaging device to track the movement of the object and eliminates any complex gesture recognition algorithms to identify the intent of the user, which further simplifies the working of the apparatus and provides an efficient alternative to gesture recognition systems. The object detector 108 in the apparatus is not limited to identifying any specific type of object for facilitating the contactless HMI functionality, which makes the apparatus more user-friendly and easier to use. The object detector 108 uses the RADAR mechanism for object identification and position tracking, thus allowing the apparatus to track objects precisely and accurately even in low-light conditions. The object detector 108 facilitates the contactless HMI irrespective of the control interface, a type of display, an aspect ratio, or a size of the display. Additionally, the apparatus overcomes the challenges of contact-based HMI devices (e.g., spreading contact infections).

While various embodiments of the present disclosure have been illustrated and described, it will be clear that the present disclosure is not limited to these embodiments only. Numerous modifications, changes, variations, substitutions, and equivalents will be apparent to those skilled in the art, without departing from the spirit and scope of the present disclosure, as described in the claims. Further, unless stated otherwise, terms such as “first” and “second” are used to arbitrarily distinguish between the elements such terms describe. Thus, these terms are not necessarily intended to indicate temporal or other prioritization of such elements.

We claim:

1. An apparatus, comprising:
an object detector configured to detect a position of an object with respect to the object detector; and
a processor that is coupled to the object detector, and configured to:
split a field of view (FOV) of the object detector into one or more FOV sectors based on one or more options on a display;
map each of the one or more options uniquely to an FOV sector of the one or more FOV sectors; and
control a movement of a pointer on the display to point to a first option of the one or more options of which the mapped FOV sector includes the detected position of the object.

2. The apparatus of claim 1, wherein the object detector includes at least one of a group consisting of (i) one or more ultra-wideband (UWB) radio detection and ranging (RADAR) transceivers, (ii) one or more moving target indication RADAR transceivers, (iii) one or more continuous wave RADAR transceivers, (iv) one or more frequency modulated wave RADAR transceivers, (v) one or more pulsed RADAR transceivers, and (vi) one or more Doppler effect RADAR transceivers.

3. The apparatus of claim 1, wherein the detected position corresponds to a horizontal angle and a vertical angle of the object with respect to the object detector.

4. The apparatus of claim 3, wherein the FOV comprises a horizontal angle range and a vertical angle range of the object detector, wherein to split the FOV into the one or more FOV sectors, the processor is further configured to split the horizontal angle range into one or more horizontal angle sub-ranges and the vertical angle range into one or more vertical angle sub-ranges, based on the one or more options, and wherein each FOV sector of the one or more FOV sectors comprises a unique combination of a horizontal angle sub-range of the one or more horizontal angle sub-ranges and a vertical angle sub-range of the one or more vertical angle sub-ranges.

5. The apparatus of claim 4, wherein the one or more options are arranged on the display in one or more rows and one or more columns.

6. The apparatus of claim 5, wherein the processor splits (i) the horizontal angle range into the one or more horizontal angle sub-ranges based on a count of the one or more columns in which the one or more options are arranged on the display, and (ii) the vertical angle range into the one or more vertical angle sub-ranges based on a count of the one or more rows in which the one or more options are arranged on the display.

7. The apparatus of claim 1, wherein the processor is further configured to control the movement of the pointer on the display to shift the pointer from the first option to a second option of the one or more options based on a change in the position of the object in at least one of a group consisting of a horizontal plane and a vertical plane.

8. The apparatus of claim 1, wherein the one or more options include one or more graphical user interface (GUI) elements.

9. The apparatus of claim 1, wherein the one or more options include at least one of a group consisting of a left scroll option, a right scroll option, an upward scroll option, and a downward scroll option, and wherein the processor is further configured to perform one of a group consisting of (i) a left scroll action on the display when the first option corresponds to the left scroll option, (ii) a right scroll action on the display when the first option corresponds to the right scroll option, (iii) an upward scroll action on the display when the first option corresponds to the upward scroll option, and (iv) a downward scroll action on the display when the first option corresponds to the downward scroll option.

10. The apparatus of claim 1, wherein the object detector is further configured to initiate the detection of the position of the object based on the object being within a threshold distance from the object detector.

11. The apparatus of claim 10, wherein the object detector is further configured to initiate the detection of the position of the object based on a time duration for which the object is within the threshold distance, exceeding a threshold time duration.

12. The apparatus of claim 1, wherein the object detector is further configured to detect a forward movement and a backward movement of the object with respect to the object detector based on a change of distance between the object and the object detector, and wherein the forward movement and the backward movement are detected after the pointer points to the first option.

13. The apparatus of claim 12, wherein the processor is further configured to perform a select action for the first option based on the detection of the forward movement and the backward movement within a defined time duration.

14. The apparatus of claim 1, wherein the object detector is further configured to select the object from a plurality of objects that are within the FOV of the object detector based on the object being nearest to the object detector among the plurality of objects.

15. The apparatus of claim 1, wherein the apparatus is a plug-and-play apparatus that interfaces with the display and functions as a contactless human-machine interface for the display.

16. A method, comprising:
detecting, by an object detector of an apparatus, a position of an object with respect to the object detector;
splitting, by a processor of the apparatus, a field of view (FOV) of the object detector into one or more FOV sectors based on one or more options on a display;
mapping, by the processor, each of the one or more options uniquely to an FOV sector of the one or more FOV sectors; and
controlling, by the processor, a movement of a pointer on the display to point to a first option of the one or more options of which the mapped FOV sector includes the detected position of the object.

17. The method of claim 16, further comprising controlling, by the processor, the movement of the pointer on the display to shift the pointer from the first option to a second option of the one or more options based on a change in the position of the object in at least one of a group consisting of a horizontal plane and a vertical plane.

18. The method of claim 16, further comprising:
detecting, by the object detector, a forward movement and a backward movement of the object with respect to the object detector based on a change of distance between the object and the object detector, wherein the forward movement and the backward movement are detected after the pointer points to the first option; and
performing, by the processor, a select action for the first option based on the detection of the forward movement and the backward movement within a defined time duration.

19. The method of claim 16, wherein the FOV is split into the one or more FOV sectors further based on at least one of a group consisting of (i) a count of one or more columns in which the one or more options are arranged on the display and (ii) a count of one or more rows in which the one or more options are arranged on the display.

20. An apparatus, comprising:
a display configured to display one or more options;
an object detector configured to detect a position of an object with respect to the object detector; and
a processor that is coupled to the object detector and the display, and configured to:
split a field of view (FOV) of the object detector into one or more FOV sectors based on the one or more options on the display;
map each of the one or more options uniquely to an FOV sector of the one or more FOV sectors; and
control a movement of a pointer on the display to point to a first option of the one or more options of which the mapped FOV sector includes the detected position of the object.
